(19) United States
(12) Patent Application Publication
(10) Pub. No.: US 2022/0257349 A1
(43) Pub. Date: Aug. 18, 2022

(54) ORTHODONTIC SYSTEM AND APPLYING METHODS

(71) Applicant: PRM LTD (ADVANCED MEDICAL SOLUTIONS), Holon (IL)

(72) Inventor: Yoav MAZOR, Holon (IL)

(73) Assignee: PRM LTD (ADVANCED MEDICAL SOLUTIONS), Holon (IL)

(21) Appl. No.: 17/667,528

(22) Filed: Feb. 8, 2022

Related U.S. Application Data
(60) Provisional application No. 63/150,551, filed on Feb. 17, 2021.

(51) Int. Cl. A61C 7/12

(52) U.S. Cl. CPC A61C 7/12

(57) ABSTRACT

A novel orthodontic apparatus for manipulating the space between teeth is disclosed. The orthodontic apparatus can be used also for moving a group of teeth forward or backward. Some embodiments of the orthodontic apparatus can comprise a telescopic connector (TC) and two pads, one at each side of the TC. Other embodiments of the orthodontic apparatus can comprise a TC, a pad in one end of the TC and a band on the other end of the TC.

### CROSS-REFERENCE TO RELATED APPLICATIONS

This utility patent application being filed in the United States as a non-provisional application for patent under Title 35 U.S.C. § 100 et seq. and 37 C.F.R. § 1.53(b) and, claiming the benefit of the prior filing date under Title 35, U.S.C. § 119(e) of the United States provisional application for patent that was filed on Feb. 17, 2021 and assigned the Ser. No. 63/150,551, which application is herein incorporated by reference in its entirety.

### FIELD OF THE DISCLOSURE

The present disclosure relates to the field of orthodontic systems and treatment methods. More particularly the disclosure relates to a novel orthodontic technique for delivering force that impose movement of one or more teeth.

### BACKGROUND

The correction of dental irregularities and malocclusions by applying controlled forces to the teeth has become commonplace. One of the most important aims for orthodontics is to arrange space for teeth in the jaw in such a manner that the teeth can be positioned properly and they can contact each other in their desired positions.

A common orthodontic technique is orthodontic headgear. During such a treatment an orthodontic appliance is attached to the patient's head with a strap or number of straps around the patient's head or neck. From this structure of straps a force is transferred to the jaw(s) of the patient. Other common device is a twin block. The purpose of a twin block is to increase the lower jaw size and establish new position by repositioning it in a more anterior position effecting the bone teeth and muscles to achieve the treatment objectives.

It is well known to a person having ordinary skill in the art that due to the appearance and the uncomfortable feeling that is associated with the orthodontic appliance, patients and especially children do not like to use them. In some cases the inconvenience leads to a dis-satisfactory results or in extreme cases, the patient may withdraw in the middle of the treatment.

BRIEF SUMMARY

The needs and the deficiencies that are described above are not intended to limit the scope of the inventive concepts of the present disclosure in any manner. The needs are presented for illustration only. The disclosure is directed to a novel technique for treating dental and skeletal malocclusions.

An example embodiment of the disclosed techniques may comprise a telescopic-connector (TC) having a female element and a male element. The male element can be configured to move freely in the female element in order to adapt the length of the TC to the distance between the teeth to which it will be associated. The diameter of an example of a female element can be in the range of 1.0 to 1.4 m″m, 1.2 m″m for example. The diameter of an example of a male element can be in the range of 0.7 to 1.3 m″m, 0.8 m″m for example

Each edge of the TC can be associated with a ball that is distorted from the TC. The angle of the bend of each ball can be in the range of 100 to 170 degrees, 135 degrees for example. The length of each element can be in the range of 7 to 28 m″m, 17.5 m″m for example.

In addition to the TC an example embodiment of the disclosed technique may comprise two pads. Each pad can have a wide banded base that is adapted to be bond to a tooth. The size of the base can be in the range of 3 to 10 m″m, 6.5 m″m for example. In some embodiments a socket, which is adapted to host the ball of the TC, is located in one side of the pad.

In some example embodiments of the disclosed technique the ball and the socket can be configured to allow movement (rotation) of the TC in the range of 220 to 290 degrees. Some sets of ball and socket can be configured to allow rotations of 270 degrees, for example. The other side of the pad can be associated with a hook that is configured to be connected with an elastic or a spring.

In order to mount an example embodiment of the disclosed orthodontic system on a jaw of a patient that needs to close a space between teeth a first pad that is associated with a male element of a TC can be bonded to an appropriate tooth, a molar for example. Next, a female element of the TC, which is associated with the second pad, can be slid over the male element until the point, which enables bonding the second pad to the relevant tooth. The relevant tooth can be a premolar or a canine, for example. In order to avoid bonding of the pad to the molar, some example embodiments of the disclosed technique may use a molar band instead of the pad.

After bonding the two pads, an elastic or a spring can be associated with hooks of the two pads. The elastic force that pulls the two pads toward each other causes the two or more captured teeth to move individually toward each other in order to close the spaces that exist in between the teeth. The capture teeth are the one or more teeth which are associated with the TC.

In order to mount an example embodiment of a TC on a jaw of a patient, which needs to open a space between teeth, a first pad that is associated with the male element of the TC can be bonded to an appropriate tooth, a molar for example. In order to avoid bonding of the pad to the molar, some example embodiments of the disclosed technique may use a molar band instead of the pad.

Next, an open coil spring can be placed around or in the female element of the TC, which has been already associated with the second pad.

Then, the female element with the coil spring can be slid over the male element, while pressing the coil spring and generating an elastic force directed to enlarge the spring back to its origin position. Then, the other pad can be placed over the relevant tooth. The relevant tooth can be a premolar or a canine. The other pad can be placed and be bonded to that tooth. After bonding the second pad, the elastic force of the spring pushes the two pads (or the pad and the molar band) away from each other and causes the two or more captured teeth to move away from each other in order to open a space between the teeth.

In some example embodiments of the disclosed technique the edge of a female element of a TC may be associated with a ball and a pad as it is disclosed above. While the edge of a male element remains without the ball. Next, the pad, which is associated with the female element, can be bonded to an appropriate tooth, a canine for example. Then, an open coil spring can be associated with the female element. The male element of the TC can be associated with a molar band via a head gear tube. Next the female element with the spring can be slid over the male section pressing the male section toward the female element pushing the spring until the molar band is above the relevant molar tooth and the band is placed around that tooth. The pressed coil may deliver elastic force to open spaces between the capture teeth. It will be appreciated by persons skilled in the art that the coil spring can be placed either before bonding the 2 parts (female+pad, male+pad) or after. The spring coil can be activated by using additional element such as a cripmpable stop.

After a period of few months, 2 to 12 months, 8 months for example, upon determining that the captured teeth are in place, the TC with the pads and the spring or the elastic can be removed.

An example of the disclosed appliance can be adapted to be used in another orthodontic treatment, a treatment in which a group of teeth needs to be moved, as a unit, posteriorly or anteriorly. In order to move a group of teeth as a unit a TC is used to define the group. The group can be teeth in the upper jaw or in the lower jaw.

In order to define a group of teeth, in the upper jaw, a first pad that is associated with a male element of the TC can be bonded to an appropriate tooth, a molar for example at one end of the group. Some example embodiments of the disclosed technique may use a molar band instead of the pad. Then, a female element that is associated with the second pad can be slid over the male element until the point, which enables to bond the second pad to the relevant tooth. The relevant tooth can be the tooth at the other end of the group, a premolar or a canine, for example. Then the second pad can be bonded to that tooth. Thus, the TC is placed above that group of teeth.

At this stage the length of the TC can be fixed by squeezing, with a dental plier, the female element over the male element. Alternatively, the length of the TC may be fixed in the appropriate length by applying a dental resin, fluid composite, bonding material, etc. via designated holes in the female element toward existing cuts on the male element or by crimping a designated crimp able stop at the junction point between the female and male elements. One or more of the disclosed techniques can be used simultaneously.

The bonded TC defines the group of teeth, in the upper jaw, which are needed to be moved as a unit. Then, on the lower jaw a hook or an element with hook can be bonded on a molar, for moving the group of teeth backward, or on a canine, for moving the group of teeth forward. A spring or an elastic can be placed between the hook (at the lower jaw) and the hook on the pad that is located at the TC. Thus, the spring or the elastic pulls the group of teeth, as a unit, toward the hook that is bonded on the lower jaw. A plastic clear retainer or a designated appliance such as the lower lingual arch for the lower teeth or such as a Nance on the upper teeth, can be used to stabilize the teeth to avoid undesired side effects

The above few paragraphs describe a process in which a group of teeth belongs to the upper jaw may be moved, as a unit, backward or forward. A person having ordinary skill in the art can modify the above disclosed process in order to move, as a unit, a group of teeth that belongs to the lower jaw. Therefore, for convenience and readability, the modified process is not described.

The foregoing summary is not intended to summarize each potential embodiment or every aspect of the present invention, and other features and advantages of the present invention will become apparent upon reading the following detailed description of the embodiments with the accompanying drawings and appended claims.

Furthermore, although specific embodiments are described in detail to illustrate the inventive concepts to a person skilled in the art, such embodiments can be modified to various modifications and alternative forms. Accordingly, the figures and written description are not intended to limit the scope of the inventive concepts in any manner.

Other objects, features, and advantages of the present invention will become apparent upon reading the following detailed description of the embodiments with the accompanying drawings and appended claims.

### BRIEF DESCRIPTION OF THE DRAWINGS

Exemplary embodiments of the present disclosure will be understood and appreciated more fully from the following detailed description, taken in conjunction with the drawings in which:

FIG. 1 schematically illustrates relevant elements of an example embodiment of a female element of a telescopic connector;

FIG. 2 schematically illustrates relevant elements of an example embodiment of a male element of the telescopic connector;

FIG. 3 schematically illustrates an example of a pad;

FIG. 4 schematically illustrates an example of an assembled telescopic connector;

FIG. 5 schematically illustrates a flowchart showing relevant processes that can be implemented for treating a patient by using the telescopic connector; and

FIG. 6 schematically illustrates a flowchart showing relevant processes that can be implemented for moving a group of teeth as a unit by using a telescopic connector.

### DETAILED DESCRIPTION OF SOME EXAMPLE EMBODIMENTS

Turning now to the figures in which like numerals represent like elements throughout the several views, in which exemplary embodiments of the disclosed techniques are described. For convenience, only some elements of the same group may be labeled with numerals.

The purpose of the drawings is to describe examples of embodiments and not for production purpose. Therefore, features shown in the figures are chosen for convenience and clarity of presentation only and are not necessarily shown to scale. Moreover, the language used in this disclosure has been principally selected for readability and instructional purposes, and may not have been selected to define or limit the inventive subject matter, resort to the claims being necessary to determine such inventive subject matter.

In this specification, these implementations, or any other form that the invention may take, may be referred to as techniques. In general, the order of the steps of disclosed processes may be altered within the scope of the invention. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

In the following description, the words “unit,” “element,” “module”, and “logical module” may be used interchangeably. Anything designated as a unit or module may be a stand-alone unit or a specialized or integrated module. A unit or a module may be modular or have modular aspects allowing it to be easily removed and replaced with another similar unit or module. Each unit or module may be any one of, or any combination of, hardware configured to execute the task ascribed to the unit or module. In the present disclosure the terms task, method, and process can be used interchangeably. In addition the terms element and section can be used interchangeably.

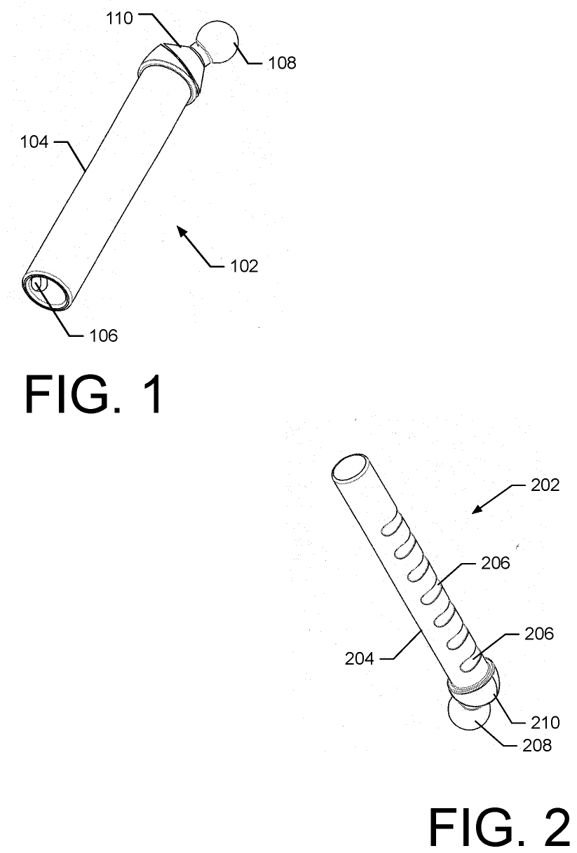

FIG. 1 schematically illustrates relevant elements of an example embodiment of a female element 102 of an example appliance. The female element 102 may comprise a female cylinder 104 of a telescopic connector (TC). The female cylinder 104 may have one or more holes 106. In the example of female cylinder 104 one hole 106 from a set of two or more holes is illustrated. The holes can be used for bringing in dental resin, fluid composite or bonding material.

The external diameter of an example female cylinder 104 can be in the range of 1.8 to 2.2 m″m, 2.0 m″m for example. The internal diameter of the example female cylinder 104 can be in the range of 1.4 to 1.8 m″m, 1.6 m″m for example. The length of the female cylinder 104 can be in the range of 10 to 20 m″m, A common length can be 15 m″m, for example. The female element 102 can be made of medical stainless steel. At the end, which is far from the hole 106, a termination with a ball 108 can be associated with the female cylinder 104 of the TC in order to generate the female element 102 of the disclosed appliance. The radios of the ball can be in the range of 0.6 to 0.9 m″m, 0.75 m″m for example.

The ball 108 can be associated with the female cylinder 104 of the TC via an adaptor 110. The adaptor 110 is configured to place the ball in an angle to the female cylinder 104. The angle of the bend of ball 108 can be the range of 100 to 170 degrees, 135 degrees for example.

FIG. 2 schematically illustrates relevant elements of an example embodiment of a male element 202 of an example of a telescopic connector (TC). The male element 202 may comprise a male cylinder 204 of the TC having a plurality of cuts 206. The cuts 206 can be configured to absorb the dental resin, fluid composite or bonding material, which may be delivered via one or more holes 106 (FIG. 1).

The external diameter of an example male cylinder 204 can be in the range of 1.3 to 1.8 m″m, 1.5 m″m for example. The internal diameter of the example male cylinder 204 can be in the range of 1.1 to 1.7 m″m, 1.4 m″m for example. The length of the example male cylinder 204 can be in the range of 10 to 20 m″m, A common length can be 15 m″m, for example. The male element 202 can be made of medical stainless steel. At the end, which is close to the cuts 206, a termination with a ball 208 can be associated with the male cylinder 204 of the TC. The radios of the ball 208 can be in the range of 0.6 to 0.9 m″m, 0.75 m″m for example.

The ball 208 can be associated with the male cylinder 204 of the TC via an adaptor 210. The adaptor 210 can be configured to place the ball in an angle to the male cylinder 204. The angle of the bend of ball 208 can be the range of 100 to 170 degrees, 135 degrees for example.

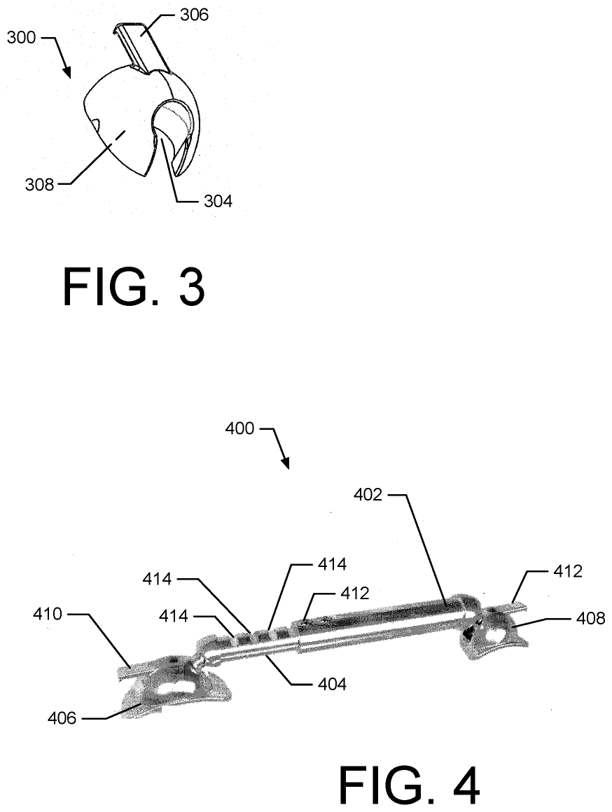

FIG. 3 schematically illustrates an example of a pad 300. Pad 300 may comprise a wide banded base 308 that is adapted to be bond to a tooth. The tooth can be molar or canine, for example. The size of the base 308 is in the range of 3 to 7 m″m, 5 m″m for example. In some embodiments a socket 304 is located in one side of the pad. The socket 304 is adapted to host ball 108 or ball 208 (FIG. 1 or FIG. 2 respectively) of a TC, In some example embodiments of the disclosed technique the ball 108 or 208 and the socket 304 are configured to allow movement (rotation) of the TC in the range of 220 to 290 degrees, for example.

The other side of the pad 302 can be associated with a hook 306 that is configured to be associated with an elastic or a spring. The height of the pad 302 can be in the range of 1.8 m″m to 2.2 m″m for example, An example value can be 2.0 m″m. The pad 302 can be made of medical stainless steel. The size of the base 308 of pad 302 depends on the size of the tooth to which it will be bonded (molar or canine). Further, in some embodiments the base 308 may be grooved in order to improve its bonding to the tooth.

In some example embodiments of the disclosed technique the pad 308 (FIG. 3) can be assembled with the male element 202, via the ball 208 (FIG. 2), at the manufacture and be delivered as a single unit to the doctor. In a similar way the female element 102, via the ball 108 (FIG. 1), can be assembled with the pad 308 (FIG. 3) at the manufacture and be delivered as a single unit to the doctor.

FIG. 4 schematically illustrates an example of an assembled TC 400. TC 400 may comprise two pads 406 and 408; each pad has a hook 410 and 412 respectively. Pad 408 is associated with a female element 402 of the assembled TC and pad 406 is associated with the male element 404 of the TC, which is inserted into the female element 402. The female element 402 comprises two holes 412 and the male element 404 has a plurality of cuts 414. The assembled TC is associated with the two pads 406 and 408 by bulls that are inserted in the socket of each pad. Pad 406 can be associated with a molar while pad 408 can be associated with a canine, for example.

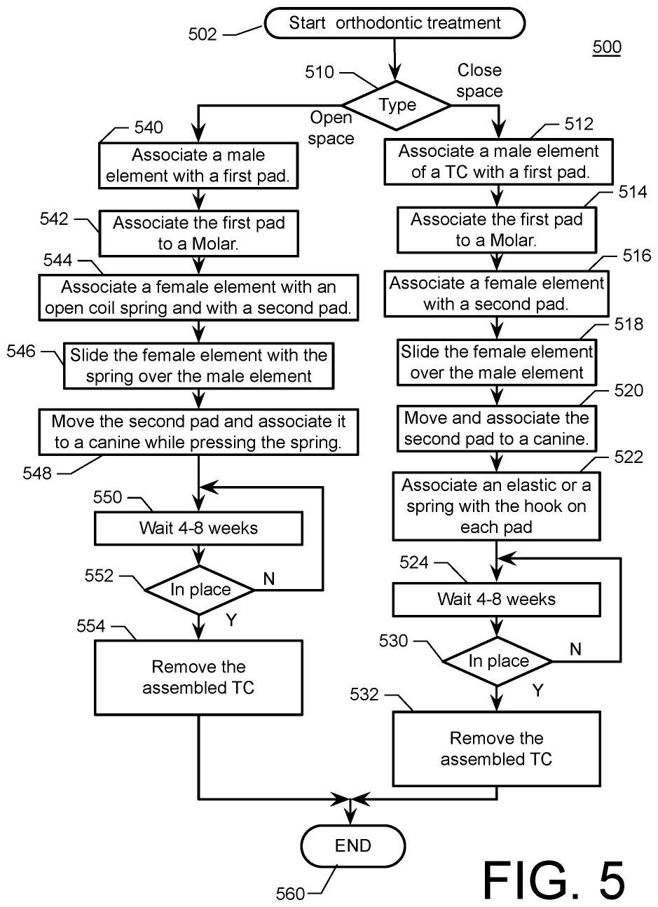

FIG. 5 schematically illustrates a flowchart 500 showing relevant processes that can be implemented for treating a patient by using a telescopic connector. At the beginning 502 of the process a decision is made 510 whether the patient need to close space between teeth or open space between teeth. If 510 the treatment is to close a space between teeth, then at block 512 a male element 404 (FIG. 4) of a TC 400 can be associated with a first pad 406 (FIG. 4), for example. Then the first pad may be associated 514 with a molar. Associating the pad 406 to the molar can be done by bonding the base 308 (FIG. 3) of the pad to the molar. In some example embodiments of the disclosed technique associating the male section 404 of the TC with the first pad is done in the manufacture and be delivered as a unit.

Another example embodiment of the disclosed technique that is using a molar band instead of pad, then at block 512 the band can be associated with the male section and be placed around 514 the molar.

At block 516 a female element 402 (FIG. 4) of the TC 400 can be associated with a second pad 408. Then slide the female element 518 over the male element until a canine. Move freely 520 the second pad and associate it 520 with the canine and, fix the second pad to the canine. In some example embodiments of the disclosed technique, associating the female element of the TC with the second pad is done in the manufacture and be delivered as a unit. Yet, in some embodiments an assembled TC 400 (FIG. 4) can be delivered as a unit from the manufacture.

Next, a spring or an elastic can be associated 522 with hook 410 (FIG. 4) and hook 412. The spring or the elastic generates a force that pulls the molar and the canine toward each other and reducing the unwanted space between the teeth that are captured by the TC and the two pads 406 and 408. The telescopic characteristic enables free movement of the male section 404 into the female element 402.

Then the patient may wait 524 for a period of 4-8 weeks, six weeks for example, before checking 530 whether the teeth are in place. If 530 the teeth are not in place the place, then the patient may wait 524 for another period of 4-8 weeks and recheck 530 the position of the teeth.

If 530 the teeth are in place, then the assembled TC 400 (FIG. 4), can be removed 532 and the treatment process can be terminated 560.

Returning now to block 510, if the treatment is to open a space between two or more teeth, then at block 540 a male element 202 (FIG. 2) of a TC can be associated with a first pad 406. Then the first pad may be associated 542 with a molar. In some example embodiments of the disclosed technique associating the male section of the TC with the first pad can be done in the manufacture and be delivered as a unit. Associating the pad to the molar can be done by bonding the base 308 (FIG. 3) of the pad to the molar. Another example embodiment of the disclosed technique that is using a molar band instead of pad, then at block 540 the band is associated with the male section and be placed around 542 the molar.

At block 544 a female element of the TC can be associated with an open coil spring and with a second pad. In some example embodiments of the disclosed technique associating the female element of the TC with the second pad can be done in the manufacture and be delivered as a unit. Then, the female element with the open coil spring can be slid 546 over the male element. Next the second pad can be moved freely, while pressing the open coil, until placing it 548 in front of a canine and associate the second pad to the canine.

The pressed open coil spring generates a force that pushes the molar from the canine for increasing the space between the teeth that are captured by the TC and the two pads 406 and 408. The telescopic characteristic enables free movement of the male section 404 out from the female element 402.

Then the patient may wait 550 for a period of 4-8 weeks, six weeks for example, before checking 552 whether the teeth are in place. If 552 the teeth are not in place the place, then the patient may wait 550 for another period of 4-8 weeks and recheck 552 the position of the teeth. If 552 the teeth are in place, then the assembled TC with the spring can be removed 554 and the treatment process can be terminated 560.

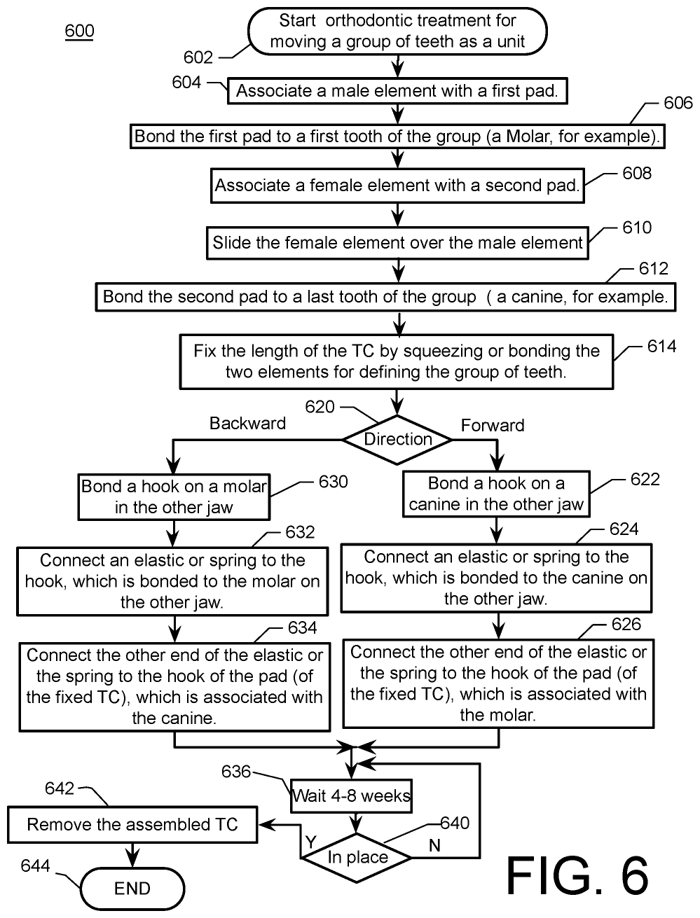

Referring now to FIG. 6 that schematically illustrates a flowchart 600 showing relevant processes that can be implemented for moving a group of teeth as a unit by using a telescopic connector (TC) 400 (FIG. 4). The group of teeth can be in a first jaw. The first jaw can be the upper jaw for example. At the beginning 602 of the process a male section 404 of TC 400 can be associated 604 with a first pad 406. In some example embodiments of the disclosed technique associating the male section of the TC with the first pad can be done in the manufacture and be delivered as a unit. Then the first pad may be associated 606 with a first tooth of the group, a molar for example. Associating the pad to the molar can be done by bonding the base 308 (FIG. 3) of the pad to the molar. Alternatively, a molar band can be used instead of bonding a pad to the molar.

At block 608 a female element of the TC can be associated with a second pad. Then, the female element with the pad can be slid 610 over the male element toward a last tooth of the group. Next, the second pad 408 can be bonded 612 to the last tooth of the group, a canine for example. In some example embodiments of the disclosed technique associating the female element of the TC with the second pad can be done in the manufacture and be delivered as a unit.

At block 614 the length of the TC can be fixed. Fixing 614 the length can be done by squeezing, with a dental plier, the female element over the male element. Alternatively the length of the TC may be fixed 614 in the appropriate length by applying a dental resin, fluid composite, bonding material, etc. via designated holes 412 (FIG. 1) in the female element toward existing cuts 414 (FIG. 2) on the male element. Fixing the length of the TC 400 defines the group of teeth, at the upper jaw, which needs to be moved.

Next, a decision is made 620 toward direction the group has to be moved. If 620 the direction of moving is forward, then a hook can be bonded 622 to a canine in the other jaw, the lower jaw for example. Then, a spring or an elastic can be associated 624 with the hook that is associated with the canine of the lower jaw. The other end of the elastic or the spring can be associated 626 with the hook of the pad that is associated with the molar at the far end of the TC. Thus, the spring or the elastic pulls forward the group of teeth, as a unit, toward the hook that is bonded on the canine of the lower jaw.

Then the patient may wait 636 for a period of 4-8 weeks, six weeks for example, before checking 640 whether the group of teeth are in place. If 640 the teeth are not in place the place, then the patient may wait 636 for another period of 4-8 weeks and recheck 640 the position of the group of teeth. If 640 the group of teeth are in place, then the assembled TC 400 (can be removed 642 and the treatment can be terminated 644.

Returning now to block 620, if the direction is moving backward, then a hook can be bonded 630 to a molar in the other jaw, the lower jaw for example. Then, a spring or an elastic can be associated 632 with the hook, which is associated with the molar of the lower jaw. The other end of the elastic or the spring can be associated 634 with the hook of the pad that is associated with the canine at the far end of the TC. Thus, the spring or the elastic pulls the group of teeth, as a unit, backward toward the hook that is bonded on the molar of the lower jaw and process 600 proceeds to block 636.

Process 600 was described as a process in which the group of teeth belongs to the upper jaw and may be moved, as a unit, backward or forward. A person having ordinary skill in the art can modify the above disclosed process in order to move, as a unit, a group of teeth that belongs to the lower jaw. Therefore, for convenience and readability, the modified process is not described.

In the description and claims of the present disclosure, each of the verbs, “comprise”, “include”, “have”, and conjugates thereof, are used to indicate that the object or objects of the verb are not necessarily a complete listing of members, components, elements, or parts of the subject or subjects of the verb.

The present disclosure has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Many other ramification and variations are possible within the teaching of the embodiments comprising different combinations of features noted in the described embodiments.

It will be appreciated by persons skilled in the art that the present invention is not limited by what has been particularly shown and described herein above. Rather the scope of the invention is defined by the claims that follow.

1. An orthodontic apparatus comprising:
i. a male element of a telescopic connector (TC) comprises a first cylinder;
ii. a female element of the telescopic connector having a second cylinder wherein the second cylinder is configured to be slid over the first cylinder;
iii. a first pad that is configured to be associated with the male element of the TC; and
iv. a second pad that is configured to be associated with the female element of the TC.

2. The orthodontic apparatus of claim 1, wherein the male element comprises a first ball that is configured to be associated with the first pad.

3. The orthodontic apparatus of claim 1, wherein the female element comprises a second ball that is configured to be associated with the second pad.

4. The orthodontic apparatus of claim 2, wherein the first pad comprising:
i. a first socket that is adapted to be associated with the first ball;
ii. a first hook located opposite to the first socket; and
iii. a first base wherein the first base is configured to be associated with a first tooth.

5. The orthodontic apparatus of claim 3, wherein the second pad comprising:
i. a second socket that is adapted to be associated with the second ball;
ii. a second hook located opposite to the second socket; and
iii. a second base wherein the second base is configured to be associated with a second tooth.

6. The orthodontic apparatus of claim 1, further comprising an elastic that is configured to be associated with the first pad and the second pad for pulling the first pad and the second pad toward each other.

7. The orthodontic apparatus of claim 1, further comprising a spring that is configured to be associated with the first pad and the second pad for pulling the first pad and the second pad toward each other.

8. The orthodontic apparatus of claim 1, further comprising an open coil spring that is adapted to be associated with the female element and is configured to be pressed between the first and the second pads while the pads are bonded to appropriate teeth.

9. The orthodontic apparatus of claim 2, wherein between the first ball and the male cylinder there is a first angle.

10. The orthodontic apparatus of claim 9, wherein the first angle is in the range of 100 to 170 degrees.

11. The orthodontic apparatus of claim 9, wherein the first angle is 135 degrees.

12. An orthodontic apparatus comprising:
i. a male element of a telescopic connector (TC) comprises a first cylinder and a first ball;
ii. a female element of the TC having a second cylinder and a band wherein the second cylinder is configured to be slid over the first cylinder; and
iii. a first pad that is configured to be associated with the male element of the TC.

13. The orthodontic apparatus of claim 12, wherein the first pad comprising:
i. a first socket that is adapted to be associated with the first ball;
ii. a first hook located opposite to the first socket; and
iii. a first base wherein the first base is configured to be associated with a first tooth.

14. The orthodontic apparatus of claim 13, further comprising an elastic that is configured to be associated with the first pad and the band for pulling the first pad and band toward each other.

15. The orthodontic system of claim 13, further comprising an open coil spring that is configured to be associated with the female element and is configured to be pressed between the first pad and the band, wherein the first pad and the band are associated with relevant teeth.

16. A method of orthodontic treatment for reducing spaces between a group of teeth, comprising:
i. employing a male element of a telescopic connector (TC) that is associated with a first pad;
ii. bonding the first pad to a first tooth from the group of teeth;
iii. employing a female element of the TC that is associated with a second pad;
iv. sliding the female element over the male element;
v. bonding the second pad to a last tooth from the group of teeth; and
vi. associating the first pad and the second pad with an elastic.

17. The method of claim 16, wherein the first tooth is a molar.

18. The method of claim 16, wherein the last tooth is a canine.

19. A method of orthodontic treatment for increasing spaces between a group of teeth, comprising:
i. employing a male element of a telescopic connector (TC) that is associated with a first pad;
ii. bonding the first pad to a first tooth from the group of teeth;
iii. employing a female element of the TC that is associated with an open coil spring and with a second pad;
iv. sliding the female element with the open coil spring over the male element; and
v. bonding the second pad to a last tooth, from the group of teeth, while pressing the open coil spring.

20. The method of claim 19, wherein the first tooth is a molar.

21. The method of claim 19, wherein the second tooth is a canine.

22. A method of orthodontic treatment for moving a group of teeth, comprising:
i. employing a male element of a telescopic connector (TC) that is associated with a first pad;
ii. bonding the first pad to a first tooth of the group, wherein the group of teeth is on a first jaw;
iii. employing a female element of the TC that is associated with a second pad;
iv. sliding the female element over the male element;
v. bonding the second pad to a last tooth of the group;
vi. fixing the length of the TC;
vii. bonding a hook on a 3^{rd} tooth, which is located on a second jaw;
viii. associating the hook with an elastic; and
ix. associating the elastic also with the second pad.

23. The method of claim 22, wherein the first tooth of the group is a molar.

24. The method of claim 22, wherein the last tooth of the group is a canine.

25. The method of claim 22, wherein the action of fixing the length of the TC is implemented by bonding.

26. The method of claim 22, wherein moving the group of teeth background is implemented when the 3^{rd} tooth is a molar.

27. The method of claim 22, wherein moving the group of teeth forward is implemented when the 3^{rd} tooth is a canine.

28. The method of claim 22, wherein the first jaw is the upper jaw and the second jaw is the lower jaw.
